(19) United States
(12) Patent Application Publication
(10) Pub. No.: US 2008/0070575 A1
(43) Pub. Date: Mar. 20, 2008

(54) Method of administering call handover between cells in a communications system

(76) Inventors: Holger Claussen, Swindon (GB); Lester Tse Wee Ho, Swindon (GB); Louis Gwyn Samuel, Swindon (GB)

Correspondence Address: Lucent Technologies Inc.;Docket Administrator - Room 3J-219, 101 Crawfords Corner Road, Holmdel, NJ, 07733-3030, US

(21) Appl. No.: 11/521,831

(22) Filed: Sep. 15, 2006

(51) Int. Cl. H04Q 7/20

(52) U.S. Cl. 455/436

(57) ABSTRACT

A communications system 1 includes an underlay network 2, which a cellular communications network implemented using UMTS technology, and an overlay home cell 8 set up by a user using a base station router 7, or other similar access device. A call may be transferred from the home cell 8 to a cell of the underlay network 2 and vice versa. If these operate at different tariffs, the user may find that handover between them results in extra charges for an on-going call.

The user terminal 10 is enabled so as to allow the user to determine if handover should be performed, and thus retain control of costs incurred in making a call. The user terminal 10 may give an alert if there is a risk of imminent handover, allowing the user to take avoiding action if desired, or the user may configure preferences to control under what conditions handover may be performed.

### FIELD OF THE INVENTION

The present invention relates to a method for administering call handover between cells in a communications system, and more particularly, but not exclusively, to a method; that permits a user to avoid unexpected tariff changes during a call.

### BACKGROUND OF THE INVENTION

Fixed network and mobile communications technologies developed separately, but now efforts are being made to draw them together in what is known as “fixed-mobile convergence” to enable landline and wireless networks to work co-operatively. This should be an attractive proposition for users, who will be able to access data, speech and video from a single mobile terminal or fixed solution, for example, with switching possible between different available technologies to most effectively deliver the content. Switching between cells of a cellular network is known as handover, or handoff. A mobile terminal may retain a connection via one cell until a connection is established with another one, or a connection may be relinquished before a new connection is made. This latter approach tends to be undesirable where the communications traffic across a connection is a real-time one, such as speech. In some arrangements, a mobile terminal maintains several simultaneous connections with different cells.

In one example of fixed-mobile convergence, part of a communications system is provided by an “underlay network”, which comprises “underlay cells”. An underlay cell is part of a wide area wireless network, such as a conventional cellular network, for example, a network implemented using UMTS, GSM, and the like, technology, or such as other wireless WANs, for example WiMax. Another part of the communications system is provided by a small, additional “home” cell, termed an “overlay home cell”. The overlay home cell is placed within an underlay cell to provide coverage within a user's home or business premises, typically using a consumer wire-line broadband connection as backhaul. The overlay home cells are created using low-powered, user-deployed “consumer” base station routers (BSRs), although other technologies such as Bluetooth devices and WLAN access points could be used, for example, through the use of Generic Access Network (GAN) technology, previously known as Unlicensed Mobile Access (UMA) technology.

Thus, in an environment where fixed and wireless communications are both available to a user, the user has a user terminal with the capability to operate seamlessly both in the overlay home cell and the underlay network, including performing handovers between overlay and underlay cells without interrupting an on-going communications session. In one envisaged scenario, each overlay home cell can only be used exclusively by the user who deploys it, so handovers between overlay home cells would not occur. Other arrangements could, however, offer this possibility, which may be useful for business use, say, if a wider area needs to be covered by the overlay part of a system.

It is anticipated that communication sessions made by a connection with the overlay home cell are likely to be subjected to a cheaper price tariff compared to those made using the underlay network. Because of this, a user terminal would have a preference to attach to the overlay home cell by default, and use the underlay network only if the overlay home cell is no longer available. However, if, during an on-going communications session, handover to an underlay cell is performed, the user may be charged at a higher tariff than he had expected.

In one method of providing pricing certainty to a user, such as the one used in the BT Fusion service proposed by British Telecommunications plc, call charges are at a tariff that is set according to where a call is initiated. Thus, a call that is initiated while connected to the overlay home cell is charged at the home cell tariff throughout the call, even if a handover to the underlay cell occurs. Similarly, a call initiated while connected to the underlay network is charged at the underlay tariff, even when a handover to the overlay home cell subsequently occurs. However, this approach is open to possible abuse by users. A user could deliberately initiate a call on the cheaper overlay home cell and then move away from the area covered by the home cell, so that the main part of the session continues at a lower tariff, but via a connection to an underlay cell. This practice might become widespread if significant differences in overlay and underlay pricing exist. However, the BT Fusion scheme may be applicable only to voice calls, which are usually estimated to average in the region of 120 or 180 seconds duration. Thus, such possible user abuse may be of limited effect, particularly since the impact of voice calls on underlay capacity is also relatively small. In contrast, data sessions are generally more prolonged and also require greater network resources to support them. For example, streaming radio or videos, large data downloads, web browsing and gaming, may involve significant connection times and resources.

### BRIEF SUMMARY OF THE INVENTION

According to an aspect of the invention, a method of administering call handover between cells in a communications system includes the step of: permitting a user of a device that communicates with the system to determine if call handover should be performed. Thus, while the system makes a decision as to whether or not handover is necessary for optimum network performance, the user is given an opportunity to decide if such a handover should actually be performed. This is particularly advantageous where a handover, if implemented, would result in an increase in the call tariff during an on-going call. This might arise where a connection is initiated with a home cell, at a lower rate, and then signal conditions change. For example, a user may be is currently listening to streaming radio on a terminal at home using the overlay home cell, where the cost of doing so would be minimal. An unexpected handover, from the user's point of view, to the underlay cell can occur due to changes in channel conditions during that session. For example, the user might move away from his home BSR or access point, or move next to a window. Previously, this may have lead to what, to the user, would be a seamless transition, with handover being automatically implemented by a network controller. The handover may incur unanticipated higher underlay network tariff charges for the user. By using the invention, in one method, the user avoids the uncertainty experienced due to changes in pricing tariffs in the event of an overlay to underlay handover. This may remove a disincentive for the user to make use of certain functionalities and services available to him. It provides the user with assurance that the expected pricing tariff is used.

Although the invention is particularly applicable to the range of possibilities offered by fixed-mobile convergence, such as using home or office based local access points in combination with a wide cellular network, the invention may additionally or alternatively be advantageously applied where there are transitions between different networks with different charging regimes. Thus, the invention may be applied where there is dynamic roaming in multi-operator environments in which different tariffs apply.

The invention is particularly useful where differential tariffs are involved, but it may also be implemented in others situations. For example, it may enable the user to retain control of the connection route so as to ensure a communication session is not transferred away from what would be a generally more reliable connection to a less desirable one.

The device, also termed herein a user terminal, may be a mobile terminal such as a cellular telephone or a laptop computer, or could be a fixed device. Although a fixed device may be less likely to experience handover because there is less likelihood of relative movement between it and a cell of a communications system, changing environmental conditions or transmitter performance, for example, could cause a handover to occur.

In one method in accordance with the invention, the steps are included of: detecting when there is an increased risk of handover of a call; and alerting the user when an increased risk is detected. This might be done by the user device emitting a warning tone or alarm, or by vibration, or by a message on a visible display, for example. Advantageously, the user is warned in a way that does not interrupt the call. The user may then be able to take appropriate action to reduce the risk of handover occurring, for example, by moving closer to the BSR or access point where the communications session is being conducted via a home overlay cell. An example of increased risk of a handover is when the signal received from the BSR drops to within a predetermined range that is close to the handover threshold. Where an alert has been given, a follow up signal might be given where the increased risk of handover has diminished in response to the user's action, for example. If avoiding action is not taken or is not successful in preventing handover, another alert might be given by the user's device to inform him of handover, so he may choose to terminate the call or make another effort to re-establish the connection via the desired route, which normally would be the one with a cheaper tariff The user may be given the option of choosing which of these alerts are to be implemented and their characteristics. Also, the user may be given the capability of selecting only to be warned for communications of a certain type where handover is an increased risk. For example, a handover might not be significant for a particular user if he is engaged in a voice call, but he may wish to be made aware if occupied with a data session.

In another method in accordance with the invention, the step is included of obtaining agreement of the user in order to initiate handover. A user may be given notification and prompted for a decision on what action to take prior to an overlay home cell to an underlay cell handover, for example. Thus, if a handover is imminent, users could be given the choice of approving the handover and continuing with the higher tariff, or dropping the session to avoid higher tariffs. This approval process may be implemented as a stand-alone feature existing only on the user terminal, or as a network feature. Implementation as a network feature allows a more formal recording of user's handover approvals for legal purposes.

User agreement may be automated by a user pre-configuring user preferences into the user terminal prior to a call. This may include simple settings, such as disabling the agreement requirement, or more complex ones where the user inputs what would be the maximum allowable tariffs for different session types, for example, for voice and data, so that handovers to acceptable new tariffs are automatically implemented.

The method of warning of increased risk of handover and that of obtaining user approval prior to handover may be alternatives or may be used in conjunction with each other. Where both options are implemented, the user may be offered a straightforward way to disable one of them in favor of the other, or to re-instate a disabled option.

According to another aspect of the invention, a user terminal for use in a communications system comprises means for permitting a user of a device to determine if call handover should be performed between cells included in the system.

According to another aspect of the invention, a communications system including an underlay cellular network and a home cell, and comprising means for permitting a user of a device that communicates with the system to determine if call handover should be performed between cells included in the system.

### BRIEF DESCRIPTION OF THE DRAWINGS

Some methods and embodiments of the present invention will now be described by way of example only, and with reference to the accompanying drawings, in which:

FIG. 1 schematically illustrates a communications system including a wide area cellular underlay and a home cell overlay;

FIG. 2 schematically illustrates a user terminal in accordance with the invention; and

FIG. 3 schematically illustrates a communications system having two networks operated at different tariffs.

### DETAILED DESCRIPTION

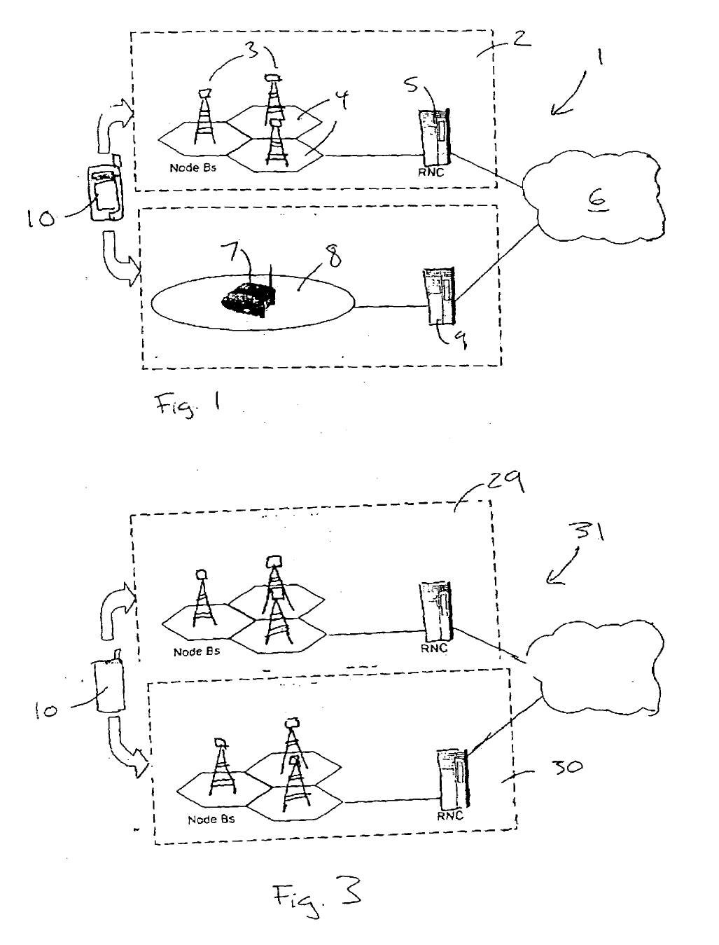

With reference to FIG. 1, a cellular communications system I includes a wide area cellular underlay network 2, which in this case is a UMTS network, having a plurality of base stations 3, each of which is associated with an underlay cell 4. The base stations 3 are controlled by a radio network controller (RNC) 5, which manages calls made via the network 2. In practice, the network 2 includes numerous RNCs and associated base stations. The RNCs control access to a core mobile network 6.

The cellular communications system I also includes a user-deployed base station router (BSR) 7, which has an associated overlay home cell 8. The user might set this up in their home or workplace, for example. The BSR 7 communicates with a home cell controller or gateway 9 to connect to the core mobile network 6. The user has a dual mode user terminal 10 for accessing the communication system 1. The user terminal is capable of communicating via a cell, or cells, of the underlay network 2 or via the home cell access afforded by the BSR 7. The tariff charged for access using the underlay network 2 is greater than that for access via the home cell 8. Thus, when the user terminal 10 is located such that access is possible via either an overlay cell or an underlay cell, the overlay cell is desirably the one that is selected. The user terminal 10 is enabled such that it pen-nits the user to be warned when there is an increased risk that handover might occur to another cell at a higher tariff.

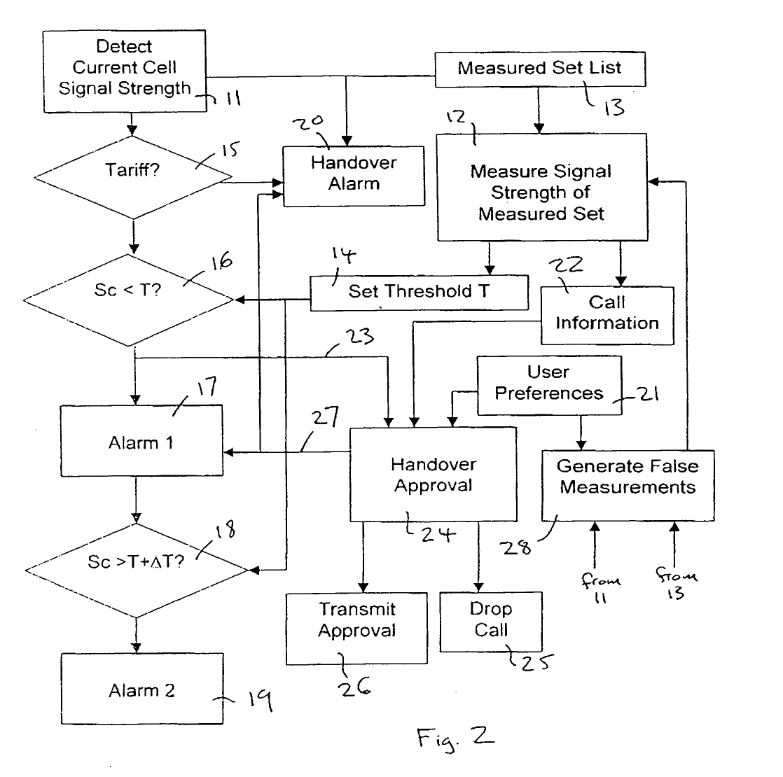

With reference to FIG. 2, the user initiates a data session, accessing the communications system I via the BSR 7 so that the connection is made via the home cell 8 at a relatively low tariff. A detector 11 is included in the user terminal 10 to monitor the strength of the signal level of the currently connected cell, that is, the home overlay cell 8. In addition, the signal strengths of a set of other cells, termed the measured set, are measured at 12. The measured set is a pre-defined list 13 of possible handover candidate cells that is transmitted to the user terminal 10 by the relevant RNC 5. The user terminal 10 transmits measurements on the cells in the measured set back to the RNC 5 for it to use in making handover decisions. In the UMTS network 2, a handover is initiated by the relevant RNC 5 when the signal of the currently connected cell becomes weaker than a certain threshold compared to other cells in the measured set of the user terminal 10. The user terminal 10 also calculates a threshold value T at 14 using the same parameters as the RNC 5. The threshold T, in this embodiment, is calculated by taking the maximum signal strength of all those cells measured at 12 and subtracting an offset value.

The tariff at which connection is made via the current cell is compared at 15 with the tariff of that cell included in the measured set which has the strongest signal, and which is used to set the threshold level T. If the tariff of the current cell is greater or equal to that of the cell of the measured set with the maximum signal strength, then no alarm mechanisms are initiated. If handover does occur, the resultant tariff will be less than that of the current cell, and thus the user does not require a-warning. However, if it is determined at 15 that the tariff of the current cell is less than that of the cell of the measured set with the maximum signal strength, an enable signal is transmitted to a comparator 16 to initiate a determination as to risk of handover.

When enabled, the comparator 16 compares the measurements of the current cell with the threshold level T. If the current cell signal strength Sc is less than T, it indicates that there is an increased risk of handover. When increased risk of handover is detected by the comparator 16, an alarm 17 is activated to alert the user. The characteristics of the alarm 17 are chosen by the user, and may be a particular audible tone or vibration, for example. On noticing the alarm, the user may choose to reduce the risk of handover occurring by, for example, moving closer to the BSR 7.

Following activation of the alarm 17, the current signal strength is compared with the threshold T by a second comparator 18. If the current signal strength increases with respect to the threshold T so that it exceeds it by a predetermined amount, this indicates that the risk of handover has diminished and handover is no longer imminent. When this condition occurs, another alarm 19 is activated to alert the user that handover is no longer imminent.

If the user decides not to disallow handover, for example, if the user moves further away from the BSR 7, and the handover condition is fulfilled at the RNC 5, then the RNC 5 sends a command to the user terminal 10 to switch to a new current cell selected from the measured set. The user terminal 10 includes a handover alarm 20 that is activated when handover occurs to alert the user. In addition, the handover alarm 20 is only enabled when the comparison of tariffs carried out by comparator 15 shows that handover would result in the call session continuing at a higher tariff.

In other devices in accordance with the invention, the arrangement is simplified and only the first alarm 17 of the three shown is included. The comparison of tariffs at 15 may also be omitted, for example, where a user only requires notification of an imminent handover. The user may be aware that he has initially connected to the lowest available tariff and only need to be warned if handover from the initial cell is a possibility. The settings may be user-configurable so that the user may set the device in accordance with his own requirements, including, for example, the number and nature of the alarms.

The user terminal 10 also includes a mechanism for acquiring explicit user approval before initiating a handover. Prior to making a call, the user inputs his preferences to a preferences store 21. The preferences include information concerning the maximum tariff the user is prepared to pay for a particular type of service. Thus, the acceptable tariff for a data call may be set at higher than that for a voice call, and this may also be further modified by the data rate available. The user may be prepared to accept a higher tariff for a data call where data can be transferred at a greater rate than a data call at a lower data rate.

During an on-going call, information about the call, such as the type of data being transferred and the data rate, is held at a call information store 22. This also holds tariff information for the cell of the measured set with the maximum signal strength, that is, the cell to which, if handover occurs, the on-going call will be transferred.

When there is a risk of imminent handover detected by the comparison of current cell signal strength with the threshold T by second comparator 16, an alert signal is applied on line 23 to a processor 24 to establish if the user approves handover. The processor 24 uses the call information at store 22 in conjunction with the user preferences at 21 to determine if the user preferences allowing handover are applicable to the proposed new cell. If the user preferences show that the tariff is not acceptable for that particular call, the call is terminated at 25. Otherwise, it is allowed to continue. A message indicating approval is transmitted at 26 to the RNC 5 where the approval is recorded. This enables a record to be kept of user agreement to the imposed tariff. Also, when handover approval is established by the processor 24, a disable signal is applied on line 27 to the first alarm 17, to prevent its operation and that of subsequent steps. The handover alarm at 20 is similarly disabled.

The user may set the user preferences such that handover is always approved at step 24 but the disable signal is not sent to the first alarm 17. Alternatively, the user preferences may be set so as to always disable the first alarm 17 but still require that an assessment of user preferences against tariff is made by the processor 24 and approval given or refused accordingly. Thus, either mechanism may be selected by the user or both in combination.

The user preferences may be set such that a specific input is required from the user to confirm handover. This requirement might be set for every instance of handover or only for those that do not meet the requirements which were previously entered and stored in preferences store 21. This permits the user to over-ride the earlier entered preferences, which might be useful, if, for example, he is at an important point in his communication session and does not wish it to be abandoned.

In other embodiments, the-user terminal may be configured so that the user is not able to change the settings, but the first alarm and/or request for explicit handover approval are still implemented.

If the user sets the user preferences to prevent handovers of calls from his home cell, this is achieved by a modification of the measurements in the measured set of the user terminal 10 that are reported to the RNC 5. In this embodiment, when the user enters a preference at store 21 that handover should be prevented in all cases, a command is transmitted to a generator 28. The generator 28 also receives an input from the detector 11, giving the signal strength of the current cell, and the list of cells included in the measured set, received from 13. False signal strength measurements for the measured set are generated. These are always made lower than the home cell measurements. The false measurements are transmitted to the measurement stage 12 where they are substituted for the actual measurements. Accordingly, the RNC 5 receives information that apparently the home cell signal strength always exceeds that associated with any other candidate cells, and no handover is instigated. No modifications to network elements are required to implement this function.

In other embodiments in accordance with the invention, the user transmits preferences to a network controller in an underlay network and these are used at the network controller in determining if handover should be performed

The communication system 1, shown in FIG. 1, comprises an underlay network 2 and a home cell 8. In another arrangement, two networks 29 and 30 are included in a communication system 31, illustrated schematically in FIG. 3, and there is no overlay cell. The user terminal 10 shown in FIG. 2 may also be used with the communication system 31, to ensure that if there is a risk of handover from the network having the lower tariff, the user can determine if such handover should go ahead or the call should be terminated. A combination of home overlay cells and several underlay networks may be accommodated in similar fashion.

The present invention may be embodied in other specific forms, and performed by other methods, without departing from its spirit or essential characteristics. The described embodiments and methods are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method of administering call handover between cells in a communications system including the step of: permitting a user of a device that communicates with the system to determine if call handover should be performed.

2. The method as claimed in claim 1 and including the steps of: detecting when there is an increased risk of handover of a call; and alerting the user when an increased risk is detected.

3. The method as claimed in claim 2 and wherein the user is alerted by an alert that is at least one of an audible and vibration alarm.

4. The method as claimed in claim 2 and including the step of monitoring signal strength and comparing it with a threshold level to detect when there is an increased risk of handover.

5. The method as claimed in claim 2 and including the step of detecting when there is an increased risk of handover by comparing signal strength measurements of a current cell carrying an on-going call, with signal strength measurements for other cells in a measured set of cells, and alerting the user when the signal strength measurement of the current cell falls below a certain level compared to the measurements for the other cells.

6. The method as claimed in claim 1 and including the step of obtaining agreement of the user in order to initiate handover.

7. The method as claimed in claim 6 and wherein agreement is obtained from the user by the user setting preferences.

8. The method as claimed in claim 7 and wherein the user sets preferences by configuring them in said device.

9. The method as claimed in claim 8 and wherein the user preferences include the maximum allowable tariffs for different session types such that handovers to acceptable new tariffs are automatic.

10. The method as claimed in claim 8 and wherein a preference to prevent handover is implemented by modifying reported signal measurements in a measured set of cells to report false measurements that are always lower than the signal strength measurements of a current cell carrying an on-going call.

11. The method as claimed in claim 2 and including the step of obtaining agreement of the user in order to initiate handover.

12. The method as claimed in claim 7 and wherein the preferences are set by the user before a call is initiated.

13. The method as claimed in claim 6 and including the step of recording the agreement of the user.

14. The method as claimed in claim 13 and wherein a record of the agreement of the user is stored at a network element in the system.

15. The method as claimed in claim 1 and where handover is between cells of an underlay system and an overlay cell.

16. The method as claimed in claim 1 and wherein the handover is between cells at different tariffs.

17. The method as claimed in claim 1 and wherein the system includes a plurality of different networks.

18. A user terminal for use in a communications system comprising means for permitting a user of a device to determine if call handover should be performed between cells included in the system.

19. The user terminal as claimed in claim 18 and including means for the user to set preferences so that handover is performed only if the user preferences are met.

20. A communications system including an underlay cellular network and a home cell, and comprising means for permitting a user of a device that communicates with the system to determine if call handover should be performed between cells included in the system.

21. A communications system as claimed in claim 20 and wherein the home cell operates at a lower tariff to cells of the underlay cellular network
